(19) United States
(12) Patent Application Publication
(10) Pub. No.: US 2019/0039265 A1
(43) Pub. Date: Feb. 7, 2019

(54) PREFORM FOR COMPOSITE MATERIALS INCLUDING NARROWED ANGLES AFTER SHAPING

(71) Applicant: Safran Nacelles, Gonfreville L'Orcher (FR)

(72) Inventors: Bertrand DESJOYEAUX, GONFREVILLE L'ORCHER (FR); Benjamin PROVOST, GONFREVILLE L'ORCHER (FR); Sébastien LOUCHARD, GONFREVILLE L'ORCHER (FR); Fabien DEPEUX, GONFREVILLE L'ORCHER (FR)

(73) Assignee: Safran Nacelles, Gonfreville L'Orcher (FR)

(21) Appl. No.: 16/155,417

(22) Filed: Oct. 9, 2018

Related U.S. Application Data
(63) Continuation of application No. PCT/FR2017/050832, filed on Apr. 6, 2017.

(30) Foreign Application Priority Data
Apr. 6, 2016 (FR) 16/53020

(51) Int. Cl. B29B 11/16; B29B 11/12; B29C 70/54; B29C 70/38; B64D 29/06

(52) U.S. Cl. CPC B29B 11/16; B29B 11/12; B29C 33/424; B29C 70/384; B64D 29/06; B29C 70/543

(57) ABSTRACT

The present disclosure relates to a preform that includes layers of textile reinforcements that are arranged in a mold by an automatic placement head and are connected to each other, and which can be dry or pre-impregnated, in order to form a part made of composite materials after curing of an impregnating resin. The part includes a folding produced by conformation of the preform after the placement of the layers of textile reinforcements. At the folding, there are spacings between at least some of the layers of textile reinforcements.

### CROSS-REFERENCE TO RELATED APPLICATIONS

This application is a continuation of International Application No. PCT/FR2017/050832, filed on Apr. 6, 2017, which claims priority to and the benefit of FR 16/53020 filed on Apr. 6, 2016. The disclosures of the above applications are incorporated herein by reference.

### FIELD

The present disclosure relates to a preform provided to form a composite material, as well as a mold intended to manufacture such a preform, methods for manufacturing these preforms, and a part made of composite materials formed from this preform.

### BACKGROUND

The statements in this section merely provide background information related to the present disclosure and may not constitute prior art.

In order to make resistant and lightweight structural elements, especially in the field of aeronautics, it is known to prepare a textile preform from dry fibers, in particular carbon fibers, by draping ribbons that are successively deposited in order to form superimposed layers or folds.

The preform is afterwards impregnated with a resin through a method for molding a liquid composite called “LCM” (Liquid Composite Molding), such as the molding by resin transfer called “RTM” (Resin Transfer Molding). Alternatively, the preform can be made with ribbons pre-impregnated with resin.

After baking the resin, a lightweight part is obtained, comprising fibers whose density and orientation are adjusted to obtain high mechanical resistance characteristics.

In both cases of dry or pre-impregnated preform, it is known to use a depositing head that provides the ribbons in order to automatically deposit them on the mold in the form of successive superimposed layers, by following the profile of this mold.

However, the depositing heads of the prior art have a certain overall dimension, this occupied volume can cause an issue of accessibility by preventing the head from going down into the cavities of the mold or into too uneven areas.

This issue arises especially in the case of a part whose section forms a sufficiently narrowed angle. One of the solutions is then to automatically drape the preform on a mold having a more open angle, and to afterwards make a shaping of this preform, which reduces this angle so as to obtain the desired final shape.

This solution can give a satisfactory result for the parts of small thickness, in particular smaller than 1 mm because, at the folding area, the difference in extended lengths of the layers according to the thickness of the part is small enough not to make too much difference in length between the inner and outer layers.

For the parts having a greater thickness, there is then a risk of forming wrinkles or beads on the inner layers of the folding comprising an extended length which is too large relative to the length required on the final shape. These defects reduce the mechanical properties of the part because the orientation and the straightness of the fibers are poorly ensured. In order to overcome this issue, a known solution includes making, by automatic draping, several elementary preforms of fibrous reinforcement whose sections are sufficiently changing to counter the phenomenon of diameter increase, and having a small thickness, in order to make afterwards a shaping of each of these preforms that is thus made without generating a bead.

All of these preforms is afterwards orderly superimposed, each having a particular shape that perfectly fits on the shape of the preceding layer. We take into account, for each layer, the folding deviations caused by its positioning in the thickness of the final element.

This solution presents an absence of beads on the final part obtained, but requires several operations of transferring and positioning the elementary preforms on each other, which is long, complex, and can generate defects.

In addition, if the final thickness of the product is significant, it may be required to provide for several different molds allowing to make the dimension deviations between distant layers, which would thereby increase the costs.

### SUMMARY

The present disclosure provides a preform comprising several textile reinforcing layers deposited on a mold by an automatic depositing head and locally bonded together, layers that can be dry or pre-impregnated, to form a part made of composite materials after baking an impregnating resin, the part having particular foldings made by shaping of the preform after depositing the reinforcing layers, the preform being remarkable in that, at the particular foldings, the reinforcement layers include, between at least some of them, a spacing or an absence of binding.

An advantage of this preform is that the spacings formed between the layers when automatically depositing the superimposed layers, allow the layers, during the final shaping of the preform that reduces the angle of the particular foldings, to narrow to each other.

By providing for the spacings calculated depending on the differences in the extended length, according to the position of the layers in the thickness, the overlength for each layer being the result of its position within the thickness and of the folding angle, after the final folding, a set of layers perfectly superimposed on each other, without wrinkles, are obtained, which gives a composite material of good quality.

Alternatively, the local non-binding of the layers by stopping the heating of the ribbons facilitates the sliding of the layers to each other during the shaping, thereby inhibiting the generation of beads.

In addition, this manufacturing method, including automatically depositing the set of layers in a same mold, without intermediate handling, is simple and cost-effective.

The preform according to the present disclosure may in addition include one or more of the following characteristics, which may be combined together.

According to one form, at the particular foldings, the reinforcing layers receive therebetween spacing inserts. These inserts provide a calibrated spacing between the layers that allows dealing with the extended length of the deposited ribbon.

In this case, the spacing inserts may be provided to be removed laterally before the shaping.

Alternatively, the spacing inserts can be provided to be dissolved in a solvent. These inserts are removed by an operation of washing the preform in the solvent.

According to another form, the reinforcing layers include a temperature-activated binder, the preform comprising, at the particular foldings and at the periphery, a portion where this binder is not activated, thereby leaving the layers unbonded.

The present disclosure also relates to a mold provided for making a preform comprising any one of the preceding characteristics, which includes, at the particular foldings, a cavity relative to the radius directly connecting the adjacent portions of these foldings. This cavity allows compensating, toward the outside of the foldings, for the additional thickness given by the superimposition of the spacing inserts.

The present disclosure in addition relates to a method for manufacturing a preform comprising any one of the preceding characteristics, including a step of automatically depositing reinforcing layers on a mold, with depositing spacing inserts between some of these layers at the particular foldings, then a step of removing these inserts.

The present disclosure, in addition, relates to a manufacturing method comprising any one of the preceding characteristics, including a step of automatically depositing reinforcing layers on a mold by a depositing head, activating a binder between these layers outside a portion at the particular foldings.

The present disclosure, in addition, relates to a part made of composite materials formed from a preform impregnated with a resin, comprising any one of the preceding characteristics.

Especially, the part made of composite material may constitute an element of a turbojet engine nacelle provided for an aircraft.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1a and 1b illustrate cross-sectional views of a preform before and after shaping, respectively, according to the prior art;

FIG. 2 is a cross-sectional view of several fine elementary performs shaped beforehand, then superimposed in order to make a thick preform according to the prior art;

FIG. 3 is a cross-sectional view of a mold for making a preform according to the present disclosure;

FIGS. 4a and 4b illustrates the different layers of the preform deposited on the mold before and after the shaping, respectively, according to the present disclosure;

FIG. 5 illustrates the different layers of the preform deposited on a mold according to one variant of the present disclosure;

FIGS. 6a and 6b illustrates a perform before and after the shaping, respectively, according to another variant of the present disclosure; and

FIGS. 7a and 7b are detailed views of the folding of the preform according to FIGS. 6a and 6b.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

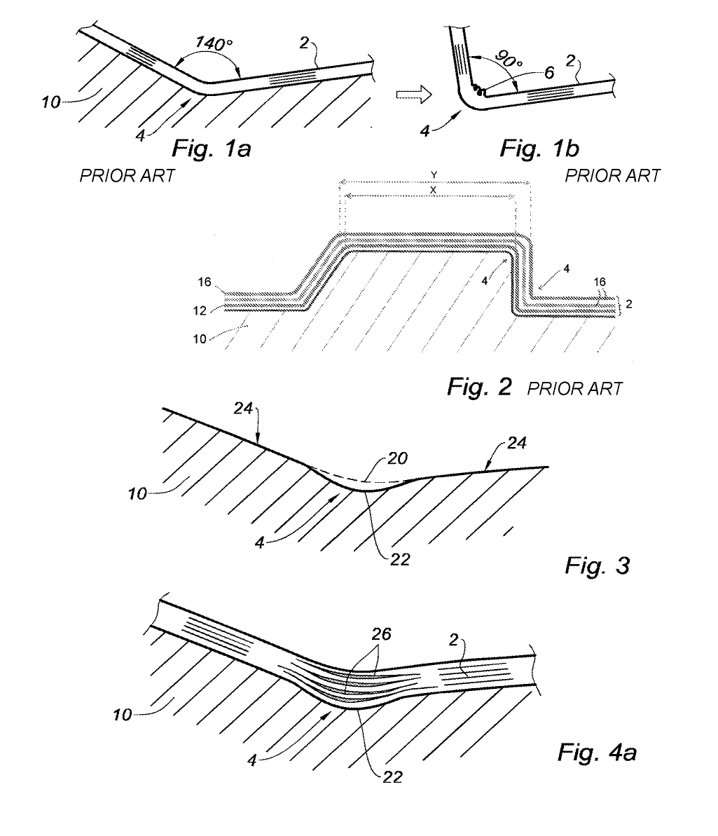

FIG. 1a shows a thick preform 2 comprising a constant thickness that may include several millimeters, formed by the superimposition of several layers of textile reinforcements. The preform 2 includes folds 4 forming an internal angle of about 140°, comprising a small connecting radius.

The shape of the folds 4 is directly given by the shape of a mold 10 receiving the layers deposited successively thereon by an automatic depositing head. The folding is limited to the angle of 140° because of the overall dimension of the automatic depositing head, that could hardly or even not be able to deposit layers within a smaller angle.

In a following operation presented in FIG. 1b, a shaping of the preform 2 comprising the folding of the folds 4 is made to obtain an angle of up to 80°. An extended length of the inner layers, which is reduced compared to that of the outer layers, is obtained at the folds 4 in the section plane.

The folds of the inner layers then form beads 6 or wrinkles by repellence of the material, which constitute a disorder in the orientation of the fibers, reducing the resistance of the part.

FIG. 2 shows a known solution to avoid the formation of beads 6 when manufacturing a thick preform 2 comprising marked folds 4 close to 90°.

A succession of thin elementary preforms 16 each having a reduced thickness, in particular smaller than 1 mm, are superimposed on a mold 10, in order to produce the thick preform 2.

In this manner, each thin preform 16 is easy to make by a method for automatically draping ribbons in a mold, followed by a shaping to form the marked folds 4 without risking to generate wrinkles inside.

However, an operation of depositing successively each thin preform 16 on the mold 10 is performed afterwards, which is a long and delicate operation.

In addition, on some portions, noticeable differences in length along the level of the thin preforms 16 are obtained, which are presented on a straight portion comprising a length X on the lower layer 12 and a significantly bigger length Y on the upper layer 14. The differences in length results in providing different draping molds to make these preforms.

FIG. 3 shows a mold 10 provided to make the previous preform 2 of FIGS. 1a and 1b, which includes, at the fold 4 a light cavity 22 relative to the radius 20 directly connecting the two adjacent planar portions 24 of this preform.

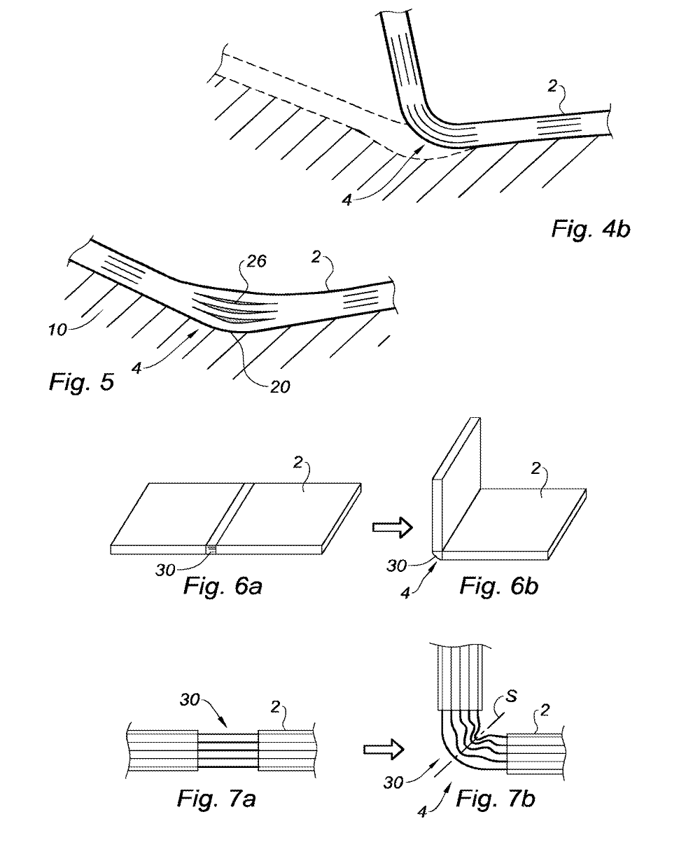

FIG. 4a shows the successive depositing of the superimposed layers on the mold 10, receiving, at the fold 4 between some of these layers, inserts 26, which are flat and tapered on the edges, that maintain a small space between these layers at the center of the fold, tapering towards the sides.

Thus, a thickening of the preform 2 is made at the fold 4, which decreases on each side to finish at the end of the fold.

According to a first form, the inserts 26 are removed on the sides after formation of the stack of layers, to leave empty spaces instead. Therefore, in one form, the inserts 26 are temporary and do not remain within a part formed from the preform.

According to a second form, the inserts 26 are formed of a material that can be dissolved in a solvent, such as a foam, for example after washing the preform with this solvent, to similarly leave empty spaces instead.

Afterwards, a shaping of the preform 2 is made, shown in FIG. 4b, which will give a narrowing of the longer lower layers towards the upper layers.

By providing for a profile and a width adapted for each insert 26, an adjustment and a plating of the layers on top of each other is obtained, which give a totally compact and even final preform, with no wrinkles.

It should be noted that, with this form comprising a cavity 22 in the mold 10, the extended length of the lower layers has been elongated.

FIG. 5 shows a variant to obtain a similar preform 2, using a mold 10 that does not include a cavity in the folding 4 relative to the radius 20 directly connecting the adjacent portions.

The successive layers are deposited by interposing, at the folds 4 between some of these layers, inserts 26, which are flat and tapered on the edges. Similarly, these inserts 26 are afterwards removed or dissolved. With this method, the extended length of the upper layers is shortened, making them follow a more direct path.

Finally, the shaping is made by folding the preform 2, which will give a narrowing of the shorter upper layers on the lower layers.

FIGS. 6a and 7a show a flat preform 2 formed by the superimposition of layers of woven ribbons impregnated with a binder.

The head for automatically depositing the layers performs a heating of the ribbons when depositing the layers, in order to activate a binder allowing to secure these layers together. This activation is made on the entire surface, except on a central strip 30 intended to form the folding.

A central strip 30 which remains flexible is obtained, with a possibility of increased displacement in the thickness of the layers to each other.

FIGS. 6b and 7b show the shaping of the preform 2 which is folded along its central strip 30 with, in this strip, an arrangement of the layers to each other that is allowed by the absence of binding giving a freedom of movement. The layers will form regular curves which are superimposed to absorb their differences in extended length.

The central strip 30 can afterwards be heated to activate the binder of the layers of the strip in order to fix the shapes in place. A folding 4 that does not include wrinkles is obtained.

It is additionally possible to perform for the same fold a mix of the different methods presented above.

Advantageously, these methods are used to make structural elements of a turbojet engine nacelle for aircrafts, having important requirements in resistance to mechanical stresses, in lightness and in resistance to aging.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The description of the disclosure is merely exemplary in nature and, thus, variations that do not depart from the substance of the disclosure are intended to be within the scope of the disclosure. Such variations are not to be regarded as a departure from the spirit and scope of the disclosure.

As used herein, the phrase at least one of A, B, and C should be construed to mean a logical (A OR B OR C), using a non-exclusive logical OR, and should not be construed to mean “at least one of A, at least one of B, and at least one of C.

What is claimed is:

1. A preform comprising:
layers of textile reinforcements deposited on a mold to form a part made of composite materials after baking an impregnating resin, the part including a folding made by shaping the preform after depositing the layers of textile reinforcements,
wherein spacings are disposed at the folding, between at least some of the layers of the layers of textile reinforcements.

2. The preform according to claim 1, wherein the layers of textile reinforcements are deposited using an automatic depositing head and are bonded together.

3. The preform according to claim 1, wherein the layers of textile reinforcements are dry or pre-impregnated.

4. The preform according to claim 1, further comprising inserts disposed within the spacings.

5. The preform according to claim 4, wherein the inserts are removed before the shaping of the preform.

6. The preform according to claim 4, wherein the inserts are formed of a material that can be dissolved in a solvent.

7. The preform according to claim 6, wherein the inserts are formed of a foam material.

8. The preform according to claim 1, wherein the layers of textile reinforcements include a temperature-activated binder, and at the folding, a portion of the temperature-activated binder is not activated.

9. The preform according to claim 1, wherein the preform is formed in a mold that includes a cavity relative to a radius directly connecting adjacent portions of the folding.

10. The preform according to claim 1 formed by a method of 1, the method comprising automatically depositing the layers of textile reinforcements on a mold; depositing inserts within the spacings between at least some of the layers of textile reinforcements at the folding; and removing the spacing inserts.

11. The preform according to claim 10, wherein a depositing head is used to automatically deposit the layers of textile reinforcements on the mold, wherein a binder is activated between the layers of textile reinforcements outside a portion at the folding.

12. The preform according to claim 1, wherein the preform is impregnated with a resin and forms a part.

13. The preform according to claim 12, wherein the part is an element of a turbojet engine nacelle provided for an aircraft.

14. A preform comprising:
layers of textile reinforcements; and
spacings disposed between at least some of the layers of textile reinforcements proximate a folding that is created once a part is formed from the preform.

15. The preform according to claim 14 further comprising inserts disposed within the spacings.

16. The preform according to claim 15, wherein the inserts are removed before the shaping of the preform.

17. The preform according to claim 16, wherein the inserts are formed of a material that can be dissolved in a solvent.

18. The preform according to claim 14, wherein the layers of textile reinforcements include a temperature-activated binder, and at the folding, a portion of the temperature-activated binder is not activated.

19. A preform comprising:
layers of textile reinforcements; and
spacings disposed between at least some of the layers of textile reinforcements proximate a folding that is created once a part is formed from the preform; and inserts disposed within the spacings,
wherein the inserts are removed before the shaping of the preform.

20. The preform according to claim 19, wherein the layers of textile reinforcements include a temperature-activated binder, and at the folding, a portion of the temperature-activated binder is not activated.
